(19) United States
(12) Patent Application Publication
(10) Pub. No.: US 2003/0137602 A1
(43) Pub. Date: Jul. 24, 2003

(54) DIGITAL TELEVISION WITH DISASSEMBLED COMPUTER

(76) Inventors: Fan-Chieh Chang, Hsinchu City (TW); Kuan-Chou Ko, Hsinchu City (TW); Kuo-Chin Huang, Hsinchu City (TW)

(21) Appl. No.: 10/248,401

(22) Filed: Jan. 16, 2003

(30) Foreign Application Priority Data
Jan. 18, 2002 (TW) 091200730

(51) Int. Cl. H04N 5/64; H04N 7/00

(52) U.S. Cl. 348/552; 348/836

(57) ABSTRACT

### Abstract of Disclosure

The present invention is that a digital television comprises an inside, a maintain cover, a panel of a front of the digital television, at least one DVD slot and an ejection button around the panel, a hollow sliding frame inside the digital television, an exit of the sliding frame facing the maintain cover, a personal computer mainframe, which comprises a case, a plurality of grooves on upper surface and lower surface of the case and being installed along a central line of the case, a handle on the case toward an end surface of the maintain cover and being capable of pushing the personal computer mainframe into the sliding frame from the exit of the sliding frame being on the reverse side of the end of the maintain cover, a protruded DVD player connecting to the DVD slot and the ejection button for fast assembling and disassembling the computer mainframe to be in maintain and upgrade and offering multiple functions and options to consumers.

### Background of Invention

1.Field of the Invention

This invention relates to a digital television, and more particularly, to the digital television with a disassembled computer.

2.Background of the Invention:

Recently the high-tech fields have being developed to an advanced stage. To satisfy the different needs of the different enterprises, the products may be tended to a variety of functions. Further more, the concept of the home theater has being broadcasted, and therefore it is more popular day by day. The stereo of video and audio lets human being concentrate their minds to improve the display device, thus, the display devices with large sizes, a LCD, a projection device, a rear projection television or the likes, are developed and put into the market fast. As trend showing, a general television working with a computing system shall be the future tendency.

Please refer to figure 1, which is a diagram view of a connection of a personal computer 12 and a display device 11 of the prior art. Wherein a display device 11 connects to a mainframe 13 of the personal computer 12 via a signal wire 14 for electrical connection. While the display device 11 showing video or image from the personal computer 12, the mainframe 13 shall be installed an interface card with supporting television signal and upgrade the personal firstly, the video or image information in personal computer 12 can then be displayed on display device 11 via the signal wire 14. As we can see, the aforesaid prior art represents that the prior display device 11 showing the image in the personal computer 12, some other related parts may be needed, such as the interface card, the television with a large screen and connection signal wires of confusing consumers. Hence, the necessary parts in prior arts may be too many to increase the cost and assemble time; on the other hand, it is with inconveniences of usage and safekeeping to make consumers select the product.

Besides, another prior art, CPU, CD, DVD player, etc combining with the display device or the above constituted accessories individually combining with the display device, is the display device with full functions or single function of personal computer. Due to the combination of the display device, the personal computer is hardly upgraded or replaced the motherboard; further that, the whole display device needs to be moved when maintaining to cause inconvenience and decrease the service efficiency. On the other hand, the full-function product has the disadvantages of high price and no option, and consumers do not satisfy it. Hence, the competitiveness may not be good in the marketing.

### Summary of Invention

The objective of the present invention is to provide a digital television with a disassembled computer, and the computer can be disassembled from the television for maintaining to enhance efficiency andservice.

The second objective of the present invention is to provide a digital television with a disassembled computer for the computer being easily assembled and disassembled or upgraded, thus consumers will have a variety of options for personal needs.

An other objective of the present invention is to provide a digital television with a disassembled computer, and the computer is in the digital television for consumers convenience.

To approach above objectives, the present invention is that a digital television comprises an inside, a maintain cover, a panel of a front of the digital television, at least one DVD slot and an ejection button around the panel, a hollow sliding frame inside the digital television, an exit of the sliding frame facing the maintain cover, a personal computer mainframe, which comprises a case, a plurality of grooves on upper surface and lower surface of the case and being installed along a central line of the case, a handle on the case toward an end surface of the maintain cover and being capable of pushing the personal computer mainframe into the sliding frame from the exit of the sliding frame being on the reverse side of the end of the maintain cover, a protruded DVD player connecting to the DVD slot and the ejection button for fast assembling and disassembling the computer mainframe.

### Brief Description of Drawings

Figure 1 is a diagram view of a connection of a personal computer and a display device in the prior art.

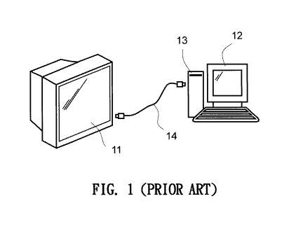

Figure 2 is a layout of a personal computer and a digital television of the present invention.

Figure 3 is a constructional view of an assembled personal computer and the digital television of the present invention.

Figure 4 is a perspective view of a personal computer mainframe of the present invention.

Figure 5 is a back view of a combination of the personal computer mainframe and the digital television of the present invention.

Figure 6 is a side view of a combination of the personal computer mainframe and the digital television of the present invention.

### Detailed Description

A preferred embodiment of the present invention will be explained with reference to the accompanying drawings.

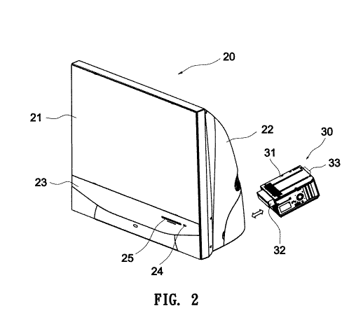

Please refer to figure 2, which shows a digital television 20 with an assembled computer of a preferred embodiment of the present invention. To open a maintain cover 26 to let a personal computer mainframe 30 be inserted into the digital television 20 from the back of the digital television 20, and therefore the personal computer mainframe 30 is fixed in the interior of the digital television 20 and combined with the digitaltelevision 20.

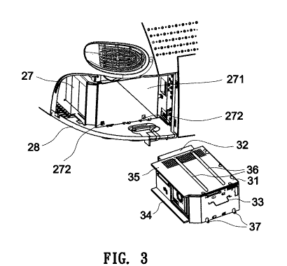

The front of the digital television 20 is a screen 21, and a panel 23 is set below the screen 21. Around an end of the panel 23 has a DVD slot 25 and an ejection button 24. A rear of the screen 21 is set a rear case 22, a maintain cover 26 is below the rear case 22, and thus an appearance of digital television 20 is formed. As shown in figure 3, to dismantle the maintain cover 26 to show an inside of digital television 20, the inside comprises a base 28, which upper surface is designed a hollow sliding frame 27, an exit 271 of an end of the sliding frame 27 faces the maintain cover 26; more, around an end of the exit 271 has plural fixing blocks 272, which uses plural fixing components (such as screws, not shown in figure) to fix on the sliding frame 27; the other end of the sliding frame 27 faces a back side of the DVD slot 25 and the ejection button 24 of the panel 23.

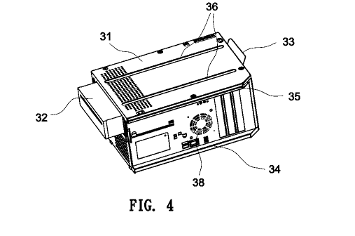

As shown in figure 4, the personal computer mainframe 30 is installed in a case 31, which inserts a DVD player 32 in the upper and front side of the case 31. A front end of the DVD player 32 protrudes out of the case 31. An upper panel and a lower panel of case 31 separately protrudes out of a side surface with an exhausting fan 38 of the case 31 to form an upper flange 35 and a lower flange 34, and then the exhausting fan 38 has a fillister on the side of the exhausting fan 38 for guiding the exhausting air. The upper panel and the lower panel individually have an upper groove 36 and a lower groove 37 along with two sides of a central line, and the two rails is slightly bulged out of two surface of the upper panel and the lower panel. A handle 33 is set-aside on mainframe 30 for conveniently assembling and disassembling the mainframe 30.

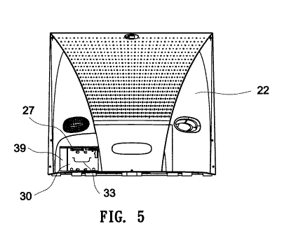

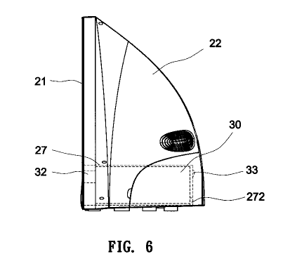

Please refer to figure 5, which is a back view of a combination of the personal computer mainframe 30 and the digital television 20 of the present invention. While in assembling the digital television 20,the maintain cover 26 and lower fixing blocks 272 are took off firstly. An end of the personal computer mainframe 30 with DVD player 32 is in exit 271 of the sliding frame 27. The lower groove 37 is put on the sliding frame of the base 28. Due to the condition of small friction of the contacting of upper rail 36, the lower grooves 37 and the sliding frame 27, the personal computer mainframe 30 is pushed into the sliding frame 27.Please refer to figure 6, while DVD player 32 touching onto the rear end of the DVD slot 25 and the ejection button 24, thus the DVD player 32 of the personal computer mainframe 30, the DVD slot 25 and the ejection button 24 are combined together. Meanwhile, the upper flange 35 and lower flange 34 of the case 31 hold sides of the sliding frame 27, therefore, the side with the exhausting fan 38, the sides of upper flange 35 and lower flanges 34 and the sliding frame 27 form a duct 39 for exhausting heat in the personal computer mainframe 30. The fixing blocks 272 are designed on a lower side of a rear end of the personal computer mainframe 30 and fasten the personal computer mainframe 30 in the sliding frame 27 to avoid falling down while in moving. At last, to cover the maintain cover 26 is to finish the assembling. On the other hand, when in maintenance, to dismantling the maintain cover 26 and the fixing blocks 272 firstly, and then holding the handle 33 to pull out the personal computer mainframe 30 by way of the upper grooves 36 and the lower groove 37.

The upper groove 36and the lower 37 can be instead of ball or bearing or the likes to be set on the sliding frame 27 or case 31 of personal computer mainframe 30. The goal is to decrease the friction. Besides, the fixing block 272 can be another type of flexible buckling. Using the type of flexible buckling is able to fast assemble and dismantle the personal computer mainframe 30.

According to above mention, the present invention is capable of approaching below functions:

1.Due to the design of the sliding frame and the groove, the personal computer mainframe can be fast assembled and dismantled to increase high efficiency and the service.

2.The personal computer mainframe is independent; therefore it is upgraded easily for consumers options and personal needs.

3.The personal computer mainframe is hidden in the digital television; therefore both are combined to become computing furniture. As it can be seen, the concept saves the room and cost in a house to simplify and convenient consumers.

Moreover, the preferable embodiment described in above section is to illustrate the invention in a detailed way and is not limitation to the scope of the invention. Those who are skilled in such arts should understand that their appropriate and slight variation and modification still keep the merits of the invention and are also within the spirit and scope of the invention.

Claims

1. What is claimed is:
1. Digital television with disassembled computer comprising:
a digital television having an inside;
a sliding frame being in the inside and a hollow body; and
a personal computer mainframe having a case and installed and supported in the inside of the sliding frame.

2.The digital television with disassembled computer of claim 1, wherein the case has an upper surface and lower surface, which are installed a plurality of grooves.

3.The digital television with disassembled computer of claim 2, wherein the grooves are installed along with a central line of the case.

4.The digital television with disassembled computer of claim 3, wherein the upper surface and the lower surface separately have the groove on two sides of the central line.

5.The digital television with disassembled computer of claim 1, wherein a front of the digital television has a panel, which one end has at least one DVD slot and an ejection button.

6.The digital television with disassembled computer of claim 5, wherein an end surface of the personal computer mainframe has a DVD player protruding out of the surface, the DVD player connects to the DVD slot and the ejection button.

7.The digital television with disassembled computer of claim 1, wherein the digital television has a maintain cover, and an exit of the sliding frame faces the maintain cover.

8.The digital television with disassembled computer of claim 7, wherein an end surface of the personal computer mainframe toward the maintain cover has at least one handle.

9.The digital television with disassembled computer of claim 1, wherein a flange is set for each of the upper surface and the lower surface of the case to form a duct of an exhausting fan.

10.The digital television with disassembled computer of claim 1, wherein around an end of an exit of the sliding frame is set a fixing block.
